(19) United States
(12) Patent Application Publication
(10) Pub. No.: US 2011/0053599 A1
(43) Pub. Date: Mar. 3, 2011

(54) SYSTEM, APPARATUS, AND METHOD FOR HANDOVER PROCEDURE

(75) Inventors: Hsien-Tsung Hsu, Taipei Hsien (TW); Yung-Ting Lee, Taipei Hsien (TW); Hua-Chiang Yin, Taipei Hsien (TW); Whai-En Chen, Taipei Hsien (TW); Ray-Guang Cheng, Taipei Hsien (TW)

(73) Assignee: BROADBAND WIRELESS TECHNOLOGY CORP., Taipei Hsien (TW)

(21) Appl. No.: 12/869,913

(22) Filed: Aug. 27, 2010

Related U.S. Application Data
(60) Provisional application No. 61/238,160, filed on Aug. 29, 2009.

(51) Int. Cl. H04W 36/00

(52) U.S. Cl. 455/436

(57) ABSTRACT

A method for a handover procedure comprises detecting a status of a backhaul connection between an original femto base station and a backbone network, and sending a handover request message including a reason code and/or flag to at least one mobile station served by the original femto base station, then the at least one mobile station re-associates with at least one base station other than the original femto base station.

### CROSS-REFERENCE TO RELATED APPLICATIONS

This application claims the benefit, pursuant to 35 U.S.C. §119(e), of provisional U.S. Patent Application Ser. No. 61/238,160, filed Aug. 29, 2009, which is incorporated herein by reference in its entirety.

### BACKGROUND OF THE INVENTION

1. Field of the Invention

The present invention relates to a system, an apparatus, and a method for handover procedure, and more particularly, to the technical field regarding the femto base station.

2. Description of the Prior Art

The IEEE 802.16 standard working group and LTE standard have included the indoor femto BS (Base Station) for the sakes of throughput enhancement, coverage extension and load balancing. The major difference between indoor femto BS and outdoor BS is the media type of backhaul link. Femto BS uses the wired connection, such as ADSL and Cable link, as the backhaul link.

The handover procedure adopted in the IEEE 802.16e, is a technique, which allows an MS (Mobile station) to change the serving BS when the channel condition between MS and serving BS is unsatisfactory. Unlike the outdoor BS, the backhaul link of femto BS may disconnect to the backbone network sometimes. If the backhaul link of femto BS fails, the femto BS can not provide any service to associated MSs and thereby every associated MS should be handed over from the serving femto BS to the other BS (such as outdoor BS or another femto BS) in order to provide continuous services even the channel condition between MS and serving femto BS is still satisfactory. However, the conventional handover procedure is designed to force an individual MS to disassociate with its serving BS and re-associated with target BS (maybe outdoor BS or another femto BS) without any reason and the MS may insist to associate with the original serving BS or immediately perform handover back to the original serving BS because the channel quality between it and the original serving BS is better than the others. It is evident that the design of the conventional handover procedure is not suitable for the femto system.

### SUMMARY OF THE INVENTION

One object of the present invention is to provide a method to command at least one mobile station to efficiently leave from an original femto base station when it can not provide service to mobile stations (such as backhaul connection failed, power down, frequency change and so on), and return to the original femto base station when the original femto base station can provide service again (such as backhaul connection recovered and power on).

To achieve the aforementioned object, the present invention provides a method for a handover procedure, comprising: detecting a status of a backhaul connection between an original femto base station and a backbone network; and sending a handover request message including a reason code to at least one mobile station served by the original femto base station, then the at least one mobile station re-associates with at least one base station other than the original femto base station.

Another object of the present invention is to provide a system to command at least one mobile station to efficiently leave from the original femto base station when it can not provide service to mobile stations (such as backhaul connection failed, power down, frequency change and so on), and return to the original femto base station when the original femto base station can provide service again (such as backhaul connection recovered and power on).

To achieve the aforementioned object, the present invention provides a system for a handover procedure, comprising: a backbone network; an original femto station base connected to the backbone network via a backhaul connection; and at least one mobile station connected to the original femto base station; wherein the original femto base station sends a handover request message including a reason code to the at least one mobile station when the original femto base station detects a failure of the backhaul connection; and wherein the at least one mobile station re-associates with at least one base station other than the original femto base station when the at least one mobile station receives the handover request message.

Further another object of the present invention is to provide an apparatus to command at least one mobile station to efficiently leave from an original femto base station when it can not provide service to mobile stations (such as backhaul connection failed, power down, frequency change and so on), and return to the original femto base station when the original femto base station can provide service again (such as backhaul connection recovered and power on).

To achieve the aforementioned object, the present invention provides a femto base station for serving at least one mobile station, comprising: an antenna; a RF circuit electrically connected to the antenna; a baseband processor electrically connected to the RF circuit; a media access controller including a reliability component electrically connected to the baseband processor; and an ADSL/CATV modem electrically connected to the media access controller and connected to a backhaul connection; wherein the femto base station sends a handover request message including a reason code and/or flag to the at least one mobile station when the reliability component detects a failure of the backhaul connection; and wherein the at least one mobile station re-associates with at least one base station other than the femto base station when the at least one mobile station receives the handover request message.

### BRIEF DESCRIPTION OF THE DRAWINGS

FIG. 1 is a schematic diagram of a system for handover procedure according to one embodiment of the present invention.

FIG. 2 is a message flow graph for handover procedure according to one embodiment of the present invention

FIG. 3 is a message flow graph for handover procedure according to another embodiment of the present invention.

FIG. 4 is a block diagram of a femto BS according to one embodiment of the present invention.

### DETAILED DESCRIPTION OF THE PREFERRED EMBODIMENTS

The present invention provides a system, method and apparatus for femto BS to drive associated MSs to another BS when the femto BS loses the backhaul connection and then callback the previously associated MSs after the femto BS recovers its backhaul connection. Advantages of the present invention will become apparent from the following detailed description.

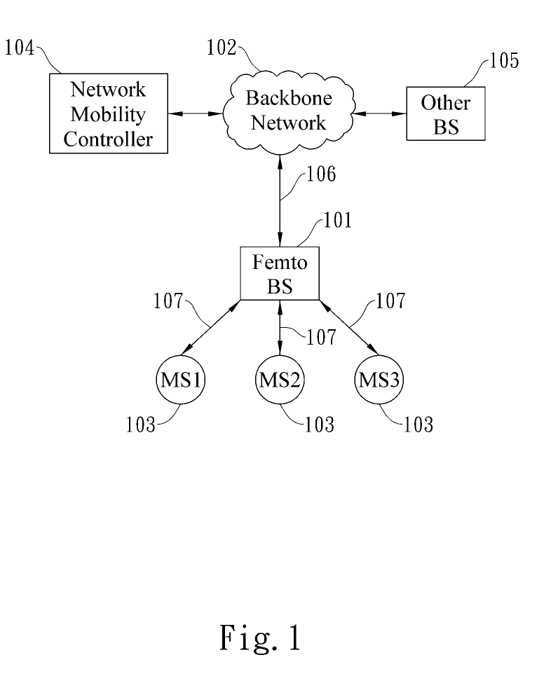

FIG. 1 illustrates a schematic diagram of a system for handover procedure according to one embodiment of the present invention. The system comprises an indoor femto BS 101, backbone network 102, three MSs 103 (MS1, MS2, MS3), a network mobility controller 104, and other BS 105. The MSs 103 is one type of subscriber station which has mobility, such as mobile phone. The femto BS communicates with the MSs 103 via a wireless connection 107 and connects to the backbone network 102 via a wired backhaul connection 106, hence the MSs 103 can connect to the backbone network 102 via the femto BS 101. The femto BS 101 also can communicate with the other BSs 105 and network mobility controller 104 via the backhaul network 102. The other BS 105 includes macro BS and/or femto BS other than the femto BS 101 that the MSs 103 can connect to. The femto BS 101 commands the MSs 103 to perform handover to the other BS when the backhaul connection 106 between the femto BS 101 and the backbone network 102 failed and commands the MSs 103 to perform handover back to the original femto BS 101 after the backhaul connection 106 is recovered.

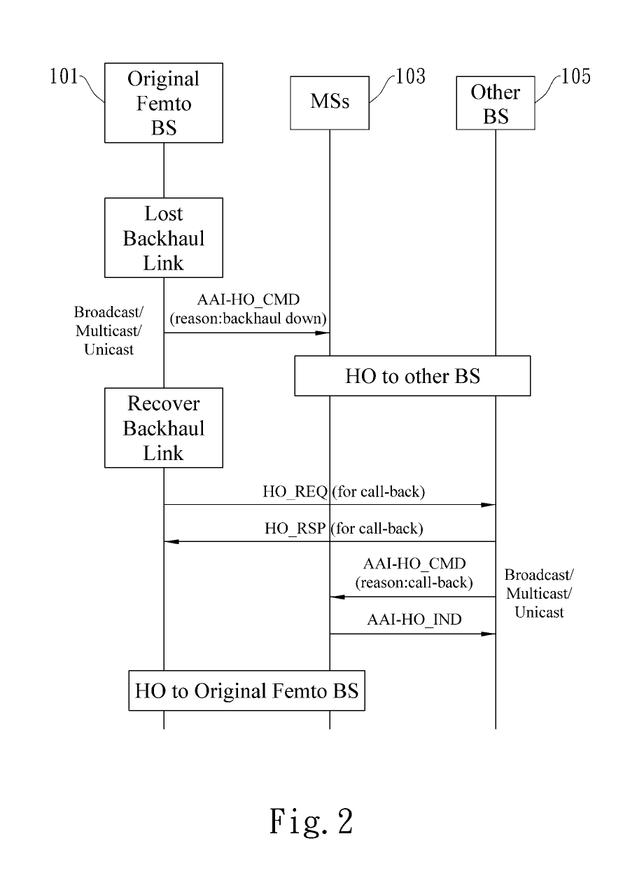

FIG. 2 illustrates a message flow graph for handover procedure according to one embodiment of the present invention. As the femto BS 101 detects a failure of the backhaul connection 106, the femto BS 101 sends a handover request message (AAI-HO_CMD) to the MSs 103 in broadcast, multicast, or unicast manner. The handover request message includes a reason code and/or specific flag used to notify the MSs 103 to handover to new BS, record the original femto BS 101 information and wait for a callback handover message. The reason code indicates the cause of the failure of the backhaul connection 106 including power down, power reduction, frequency assignment change, backhaul connection down, and so on. After the MSs 103 receive the handover request message, the MSs 103 re-associate with the other BS 105 and wait for the callback handover message, wherein the other BS 105 includes macro BS and/or femto BS other than the original femto BS 101 that the MSs 103 can connect to.

As the backhaul connection 106 is fully recovered, the femto BS 101 sends a callback handover request message (HO_REQ) to the other BS 105 for notifying the MSs 103 about the callback notification. It should be mentioned that the femto BS 101 knows which BS (i.e. the other BS 105) connected with MSs 103 because the femto BS 101 sending a BS list with the handover request message at the same time to the MSs 103. Alternatively, the femto BS 101 can know which BS (i.e. the other BS 105) connected with MSs 103 via the network mobility controller 104 or a few of BS in a specific area covering the MSs 103. After the other BS 105 receives the callback handover request message, the other BS 105 sends a receipt of the callback handover request message (HO_RSP) to the original femto BS 101 in response to the received callback handover request message and then sends a callback handover command message (AAI-HO_CMD) with reason code to the MSs 103. Upon the MSs 103 receiving the callback handover command message and callback reason from the other BS 105, the MSs 103 will sends an indication message (AAI-HO_IND) to the other BS 105 to indicate the handover event if the handover policy decides to handover back to the original femto BS 101. Finally, the MSs 103 can know which BS is the original femto BS 101 and re-associates with the original femto BS 101 because the MSs 103 have recorded the information of the original femto BS 101. In one embodiment of the present invention, the other BS 105 may sends information of the original femto BS 101 with the callback handover command message to the MSs 103 at the same time so as to notify the MSs 103 that which BS (i.e. the original femto BS) they can connect to if the MSs 103 did not or can not record the information of the original femto BS 101.

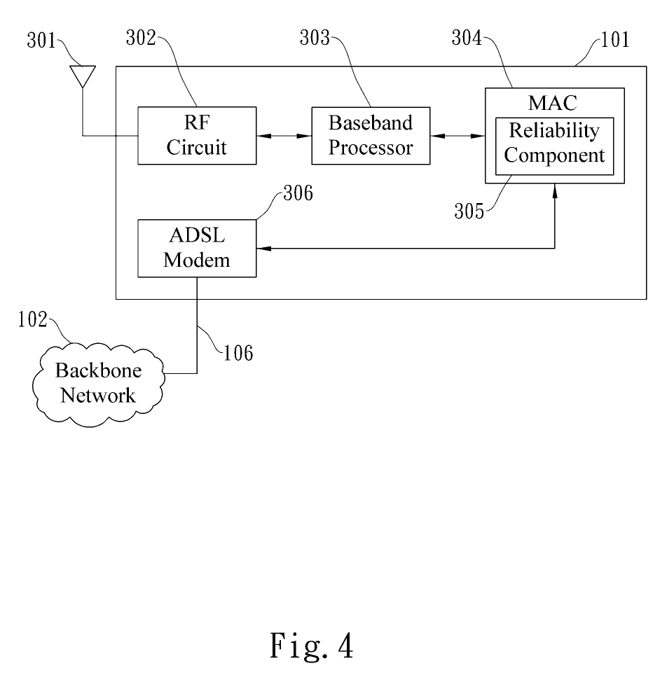

Refer to FIG. 4 illustrating a block diagram of the femto BS 101 according to one embodiment of the present invention, the femto BS 101 includes an antenna 301, a RF circuit 302, a baseband processor 303, a media access controller (MAC) 304, and an ADSL/CATV modem 306. The RF circuit 302 electrically connects to the antenna 301 and the baseband processor 303. The MAC 304 including a reliability component 305 electrically connects to the baseband processor 303 and the ADSL/CATV modem 306. The reliability component 305 is used to detect a status (failure or recovery) of the backhaul connection 106 and identify cause of failure of the backhaul connection 106. The reliability component 305 may connect to other components of the femto BS 101 to identify cause of failure of the backhaul connection 106. For example, the reliability component 305 electrically connects to the ADSL/CATV modem 306 to detect whether the backhaul connection 106 is down or not. For another example, the reliability component 305 electrically connects to a power control circuit (not shown) to detect whether the power is down or not. The femto BS 101 generates the reason code according to cause of failure of the backhaul connection 106 detected by the reliability component 305.

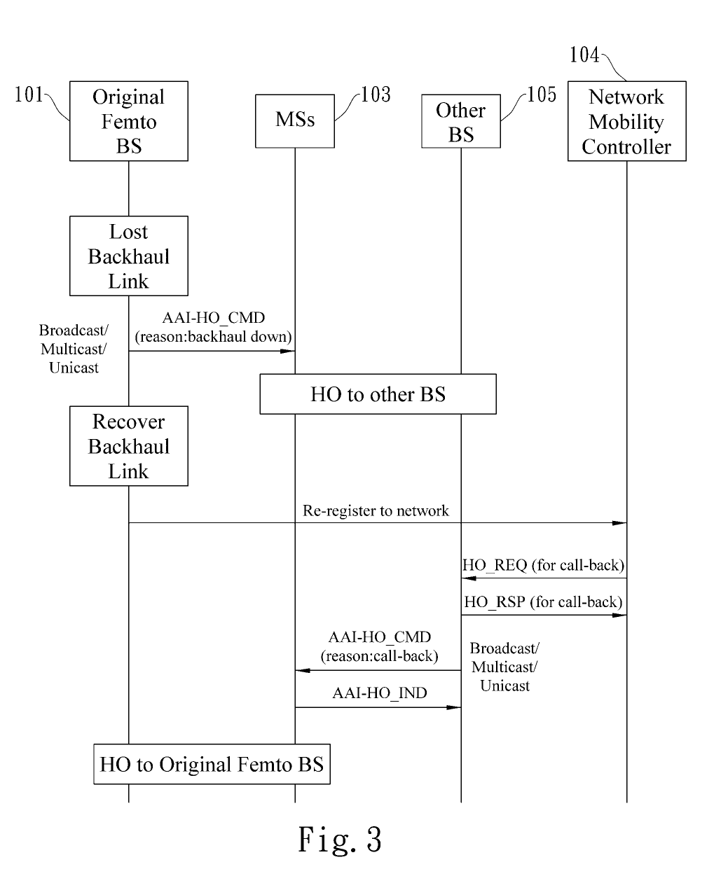

FIG. 3 illustrates a message flow graph for handover procedure according to another embodiment of the present invention. As the femto BS 101 detects a failure of the backhaul connection 106, the femto BS 101 sends a handover request message (AAI-HO_CMD) to the MSs 103 in broadcast, multicast, or unicast manner. The handover request message includes a reason code and/or specific flag used to notify the MSs 103 to handover to new BS, record the original femto BS 101 information and wait for a callback handover message. The reason code indicates the cause of the failure of the backhaul connection 106 including power down, power reduction, frequency assignment change, backhaul connection down, and so on. After the MSs 103 receive the handover request message, the MSs 103 re-associate with the other BS 105 and wait for the callback handover message, wherein the other BS 105 includes macro BS and/or femto BS other than the original femto BS 101 that the MSs 103 can connect to. The other BS 105 may notify the network mobility controller 104 about the handover events of MSs.

As the backhaul connection 106 is fully recovered, the original femto BS 101 sends a re-registration message to the network mobility controller 104 in order to trigger the network mobility controller 104 to send a callback handover command message (HO_REQ) to the other BS 105 for notifying the other BS 105 about the callback notification. After the other BS 105 receives the callback handover request message, the other BS 105 sends a receipt of the callback handover request message (HO_RSP) to the network mobility controller 104 in response to the received callback handover request message and then sends a callback handover command message (AAI-HO_CMD) to the MSs 103. Upon the MSs 103 receiving the callback handover command message and callback reason from the other BS 105, the MSs 103 will sends an indication message (AAI-HO_IND) to the other BS 105 to indicate the handover event if the handover policy decides to handover back to the original femto BS 101. Finally, the MSs 103 re-associates with the original femto BS 101. In one embodiment of the present invention, the other BS 105 may sends information of the original femto BS 101 with the callback handover command message to the MSs 103 at the same time so as to notify the MSs 103 that which BS (i.e. the original femto BS) they can connect to if the MSs 103 did not or can not record the information of the original femto BS 101.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for a handover procedure, comprising:
detecting a status of a backhaul connection between an original femto base station and a backbone network; and
sending a handover request message including a reason code and/or flag to at least one mobile station served by the original femto base station, then the at least one mobile station re-associates with at least one base station other than the original femto base station.

2. The method of claim 1, further comprising:
sending a callback handover request message to the at least one base station;
sending a callback handover command message to the at least one mobile station in response to the callback handover request message; and
re-associating the at least one mobile station with the original femto base station.

3. The method of claim 2, further comprising: sending a re-registration message to a network mobility controller.

4. The method of claim 1, wherein the at least one base station other than the original femto base station comprises at least one femto base station other than the original femto base station.

5. The method of claim 1, wherein the at least one base station other than the original femto base station comprises at least one macro base station.

6. The method of claim 1, wherein sending the handover request message including the reason code to the at least one mobile station is in broadcast manner, multicast manner or unicast manner.

7. The method of claim 1, wherein the reason code and/or flag is used to notify the at least one mobile station to record information of the original femto base station and wait for a callback handover message.

8. The method of claim 1, wherein the reason code indicates power down, power reduction, frequency assignment change or backhaul connection down.

9. A system for a handover procedure, comprising:
a backbone network;
an original femto station base connected to the backbone network via a backhaul connection; and
at least one mobile station connected to the original femto base station;
wherein the original femto base station sends a handover request message including a reason code and/or flag to the at least one mobile station when the original femto base station detects a failure of the backhaul connection; and
wherein the at least one mobile station re-associates with at least one base station other than the original femto base station when the at least one mobile station receives the handover request message.

10. The system of claim 9, wherein the at least one base station other than the original femto base station sends a callback handover command message to the at least one mobile station and the at least one mobile station re-associates with the original femto base station when the original femto base station detects a recovery of the backhaul connection.

11. The system of claim 10, wherein the original femto base station sends a callback handover request message to the at least one base station other than the original femto base station.

12. The system of claim 10, wherein the original femto base station sends a re-registration message to a network mobility controller and the network mobility controller sends a callback handover command message to the at least one base station other than the original femto base station.

13. The system of claim 9, wherein the at least one base station other than the original femto base station comprises at least one femto base station other than the original femto base station.

14. The system of claim 9, wherein the at least one base station other than the original femto base station comprises at least one macro base station.

15. The system of claim 9, wherein the original femto base station sends the handover request message including the reason code and/or flag to the at least one mobile station in broadcast manner, multicast manner or unicast manner.

16. The system of claim 9, wherein the reason code is used to notify the at least one mobile station to record information of the original femto base station and wait for a callback handover message.

17. The system of claim 9, wherein the reason code indicates power down, power reduction, frequency assignment change or backhaul connection down.

18. A femto base station for serving at least one mobile station, comprising:
an antenna;
a RF circuit electrically connected to the antenna;
a baseband processor electrically connected to the RF circuit;
a media access controller including a reliability component electrically connected to the baseband processor; and
an ADSL modem electrically connected to the media access controller and connected to a backhaul connection;
wherein the femto base station sends a handover request message including a reason code and/or flag to the at least one mobile station when the reliability component detects a failure of the backhaul connection, wherein the at least one mobile station re-associates with at least one base station other than the femto base station when the at least one mobile station receives the handover request message.

19. The femto base station of claim 18, wherein the femto base station sends a callback handover request message to the at least one base station other than the femto base station when the reliability component detects a recovery of the backhaul connection.

20. The femto base station of claim 18, wherein the femto base station sends a re-registration message to a network mobility controller when the reliability component detects a recovery of the backhaul connection.

21. The femto base station of claim 18, wherein the femto base station sends the handover request message including the reason code and/or flag to the at least one mobile station in broadcast manner, multicast manner or unicast manner.

22. The femto base station of claim 18, wherein the reason code and/or flag is used to notify the at least one mobile station to record information of the base station and wait for a callback handover message.

23. The femto base station of claim 18, wherein the reason code and/or flag indicates power down, power reduction, frequency assignment change or backhaul connection down.
